(19) United States
(12) Patent Application Publication
(10) Pub. No.: US 2021/0260621 A1
(43) Pub. Date: Aug. 26, 2021

(54) ACTUATOR CONTROL DEVICE AND METHOD

(71) Applicant: DONGWOON ANATECH CO., LTD., Seoul (KR)

(72) Inventors: Su Yeol LEE, Seoul (KR); Tae JIN, Seoul (KR); Tae Kyeong YOO, Seoul (KR)

(73) Assignee: DONGWOON ANATECH CO., LTD., Seoul (KR)

(21) Appl. No.: 17/255,932

(22) PCT Filed: Jun. 14, 2019
(86) PCT No.: PCT/KR2019/007175

§ 371 Date: Dec. 23, 2020

(30) Foreign Application Priority Data
Jun. 28, 2018 (KR) 10-2018-0074696

(51) Int. Cl. B06B 1/02; G06F 3/01

(52) U.S. Cl. CPC B06B 1/0276; G08B 6/00; G06F 3/016

(57) ABSTRACT

The present invention relates to a haptic feedback system and, specifically, to a device and method for controlling an actuator for haptic feedback, the method comprising: an actuator resonance frequency correction driving step of driving an actuator by repeatedly generating and outputting a drive signal including a driving time interval in which driving voltage is applied to the actuator and a guard time interval in which a back electromotive force (BEMF) signal of the actuator is detected, while correcting the length of the driving time interval according to detection time of a zero cross point of the BEMF signal detected within the guard time interval; and an actuator braking step of outputting at least one brake signal in synchronization with a zero cross point of the BEMF signal detected within the guard time interval, in order to remove residual vibration of the actuator.

### TECHNICAL FIELD

The present invention relates to a haptic feedback system, and more particularly, to a device and method for controlling an actuator for haptic feedback.

### BACKGROUND ART OF THE INVENTION

A haptic feedback system is mounted and used in various devices for a user interface. For example, haptic feedback is provided to a user through vibration from a touch screen, a softkey, a home button, and a fingerprint recognition sensor of a portable device. Recently, a vibration feedback system has also been installed in many devices including touch screens such as automobiles and home appliances.

A linear Resonance Actuator (LRA) is used as a means of generating vibration in a haptic feedback system. The linear resonance actuator has characteristics in that a maximum vibration with optimum power efficiency can be obtained only when it is driven at the resonance frequency (f₀).

The resonant frequency of the linear resonant actuator can vary with manufacturing tolerances, mounting conditions, temperature, and aging. In addition, when driving outside the resonance frequency, the vibration force may be weakened or vibration may not occur. Therefore, in order to obtain maximum acceleration with a small driving time in general vibration such as an alert vibration, it must be operated at the resonance frequency of the actuator. To this end, it is necessary to correct in real time the resonant frequency of the actuator, which can be varied according to manufacturing tolerances, mounting conditions, temperature, and aging.

In addition, in recent years, instead of removing a physical button for waterproof function and screen expansion of a portable device, a touch button is used, and vibration feedback is also used to implement a click feeling like a physical button in a touch button. In this case, vibration feedback is generated with an acceleration of 1G or more in a short driving time of 10 ms to 20 ms, and after the actuator stops driving, the smaller the residual vibration, the more a click feel like pressing a physical button is reproduced.

In general, to reduce the residual vibration of the actuator, it detects the zero cross point of the back electro motive force (BEMF) signal and the magnitude of the BEMF signal and automatically generates and controls the brake signal, but when the driving time is very short or the magnitude of the BEMF signal is small, it is difficult to generate an effective waveform of the brake signal that can reduce residual vibration of the actuator. Therefore, there is a need for an effective method to minimize the magnitude of the residual vibration and the residual vibration time of the actuator in a haptic feedback system.

### PRIOR ART LITERATURE

### Patent Literature

(Patent Literature 1) Korean Registered Patent Publication No. 10-1799722

(Patent Literature 2) Korean Registered Patent Publication No. 10-1703472

### SUMMARY OF INVENTION

### Technical Problems

Accordingly, the present invention is an invention devised in accordance with the above-described necessity, and an objective of the present invention is to provide a control device and a control method for a linear resonance actuator capable of correcting the resonant frequency of the actuator that is varied according to manufacturing tolerances, mounting conditions, temperature, and aging in real time, thereby obtaining a maximum vibration with optimal power efficiency.

Further, another objective of the present invention is to provide a control device and a control method for a linear resonant actuator capable of tracking drive signal waveforms that generate vibrations of various feelings according to the resonant frequency.

Yet another objective of the present invention is to provide an actuator control device and method capable of controlling an actuator to obtain a click feeling as if a physical button was manipulated even though a touch button is manipulated.

### Technical Solution

An actuator control method according to an embodiment of the present invention for solving the above-described technical problem is an actuator control method having a resonant frequency, and the method is characterized by comprising:

an actuator resonance frequency correction driving step repeatedly generating and outputting a drive signal including a driving time interval for applying a driving voltage to the actuator and a guard time interval for detecting a Back Electro Motive Force (BEMF) signal of the actuator, and driving the actuator by correcting the length of the driving time interval according to the detection time of the zero cross point of the BEMF signal detected within the guard time interval; and

an actuator braking step of outputting one or more of brake signals in synchronization with a zero cross point of the BEMF signal detected within the guard time interval in order to remove residual vibration of the actuator.

Furthermore, in the actuator resonance frequency correction driving step,

it is characterized in that the driving time interval is shortened when the zero cross point detection time of the BEMF signal is ahead of the pre-stored reference zero cross point detection time, and the driving time interval is extended when it is behind the reference zero cross point detection time, and

in the actuator braking step,

it is characterized in that brake signals having different frequencies and sizes are continuously outputted.

Meanwhile, an actuator control device according to another embodiment of the present invention is a device for controlling an actuator having a resonance frequency, and comprises:

a zero cross point detection unit for detecting a zero cross point of the BEMF signal according to the driving of the actuator; and

a resonance frequency correction unit for generating and outputting a drive signal for driving the actuator at a resonance frequency,

wherein the resonance frequency correction unit is characterized by repeatedly generating and outputting a drive signal including a driving time interval for driving the actuator and a guard time interval for detecting the BEMF signal of the actuator, and generates and outputs a drive signal whose length of the driving time interval is corrected according to the zero cross point detection time of the BEMF signal detected within the guard time interval,

wherein the resonance frequency correction unit is also characterized by outputting one or more brake signals in synchronization with the zero cross point of the BEMF signal detected within the guard time interval for removing residual vibration of the actuator, and

wherein the resonance frequency correction unit is further characterized by comprising:

a memory for storing drive signal waveform data and brake signal waveform data for driving the actuator;

a data correction unit for adjusting the number of data of the drive signal waveform according to the detection time of the zero cross point of the BEMF signal; and

a PWM generation unit for generating a PWM pulse corresponding to the input internal clock and the data number-adjusted drive signal waveform data to output to an actuator drive unit.

### Advantageous Effects of Invention

According to the above-described problem solving means, the present invention drives the actuator with an initial drive signal waveform, and since it tracks the resonance frequency of the actuator in a way that the length of the driving time interval of the next cycle is corrected according to the detection time of the zero cross point of the BEMF signal in the guard time interval constituting the drive signal, there is an advantage that the maximum vibration can be obtained with optimal power efficiency by correcting the resonance frequency of the actuator that is varied with the manufacturing tolerances, mounting conditions, temperature, and aging, in real time.

In addition, since the present invention stores waveform data of a drive signal and adjusts the frequency, it is possible to implement vibrations of various feelings by driving various waveforms at a resonance frequency, and the effect of adjusting the maximum acceleration and minimizing the dispersion of the actuator acceleration can also be obtained by optimizing the waveform data of the drive signal stored in the memory.

Also, after finding the waveform of the brake signal optimized for the actuator by an experimental method and storing it in memory, then by applying a brake signal in a direction that interferes with residual vibration to coincide with the zero cross point detected in the interval after the actuator is driven, there is an advantage that residual vibration can be stably removed even when a waveform with a short driving time or a small size of a BEMF signal like a home button.

### BRIEF DESCRIPTION OF DRAWINGS

FIG. 1 is an exemplary block diagram of an actuator control device according to an embodiment of the present invention.

FIG. 2 is a flow chart for explaining an actuator control method according to an embodiment of the present invention.

FIGS. 3 and 4 are exemplary views of drive signal waveforms for explaining an embodiment of the present invention.

FIGS. 5 to 7 are exemplary views of brake signal waveforms for explaining an embodiment of the present invention.

### DETAILED DESCRIPTION OF EMBODIMENTS

Hereinafter, preferred embodiments of the present invention will be described in detail with reference to the accompanying drawings. In describing the present invention, when it is determined that a detailed description such as a related known function or configuration may unnecessarily obscure the gist of the present invention, a detailed description thereof will be omitted. For example, the actuator control device according to the embodiment of the present invention is applicable to a haptic feedback system, and it is assumed that the device to which the present invention can be applied includes a touch-sensitive surface or other type of interface, and the actuator, and it is assumed that vibration by the actuator is generated on the touch surface.

Meanwhile, among terms used below, the term ‘drive waveform’ refers to a waveform applied to the actuator during a driving time interval constituting a drive signal, and it can be interpreted in a way that adjusting the length of the driving time interval means a change in the driving waveform.

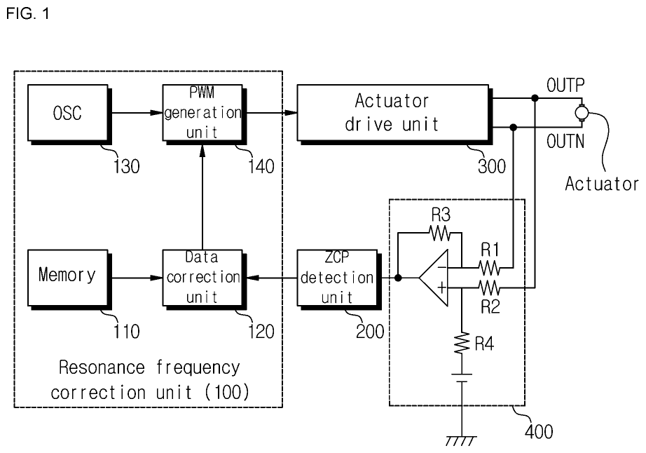

First, FIG. 1 is an exemplary block diagram of an actuator control device according to an embodiment of the present invention.

As illustrated in FIG. 1, the haptic feedback system includes an actuator having a resonance frequency as a means for generating vibration on the touch surface, for an example, and an actuator drive unit 300 for driving the actuator according to a drive signal generated by a resonance frequency correction unit 100, which will be described later. Since the actuator drive unit 300 includes a gate driver and an H-bridge circuit as already known to public, a detailed description thereof will be omitted.

Referring to FIG. 1, the actuator control device according to the embodiment of the present invention comprises:

a zero cross point detection unit 200 for detecting a zero cross point (hereinafter referred to as ZCP) of a back electro motive force (hereinafter referred to as BEMF) signal according to the actuator driving; and

a resonance frequency correction unit 100 for generating and outputting a drive signal for driving an actuator at a resonance frequency.

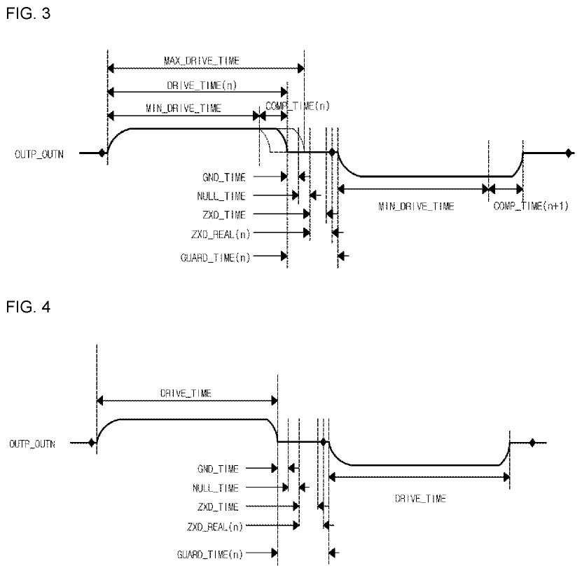

The resonance frequency correction unit 100, as illustrated in FIG. 3, repeatedly generates and outputs a drive signal including a driving time (DRIVE_TIME) interval for driving the actuator and a guard time (GUARD_TIME) interval for detecting the BEMF signal of the actuator,

wherein a drive signal in which the length of the driving time interval is corrected according to the detection time of the zero cross point (ZCP) of the BEMF signal detected within the guard time interval.

Such a resonance frequency correction unit 100 can be configured to comprise:

a memory 110 for storing drive signal waveform data (which can be defined as a reference or initial drive signal waveform) for driving the actuator;

a data correction unit 120 that adjusts the number of data of the drive signal waveform according to the detection time of the zero cross point (ZCP) of the BEMF signal according to the actuator driving; and

a PWM generation unit 140 that generates a PWM pulse corresponding to the input internal clock (OSC) and the waveform data of the drive signal whose number of data is adjusted, and outputs it to the actuator drive unit 300.

Of course, the memory 110 and the data correction unit 120 may be implemented as one processor, and such a processor may also be implemented as a processor that controls the overall operation of a device on which the haptic feedback system is mounted.

The resonance frequency correction unit 100 that can be implemented with hardware as well as software logic shortens the driving time interval if the detection time of the zero cross point (ZCP) of the BEMF signal detected in the guard time interval of the drive signal is ahead of the zero cross point detection time of the pre-stored reference value, and generates and outputs a drive signal with an extended driving time interval if it is behind the zero cross point detection time of the reference value.

Furthermore, in order to eliminate residual vibration of the actuator, the resonance frequency correction unit 100 outputs one or more brake signals (BRAKE) in synchronization with the zero cross point (ZCP) of the BEMF signal detected within the guard time (GUARD TIME) interval included in the drive signal, and may also make the brake signals to have different frequencies and sizes. In addition, the resonance frequency correction unit 100 outputs a plurality of brake signals, but it is also possible to repeatedly output the size of one brake signal among the plurality of brake signals by adjusting the size according to a scale down ratio.

Meanwhile, an actuator control device according to an embodiment of the present invention may further include a BEMF amplification unit 400 located at the front end of the zero cross point detection unit 200 to amplify the fine-sized BEMF signal for detecting the zero cross point in the ZCP detection unit.

For reference, in order to accurately detect the zero cross point, it is necessary to distinguish between the BEMF signal and the noise signal. To this end, a noise band is set at the front end of the ZCP detection unit 200 to ignore BEMF signals of less than a certain size. In other words, if the BEMF signal is amplified and two comparators using the low and high threshold voltages from the amplified signal are configured, then the voltage within the threshold band is treated as noise.

Hereinafter, the operation of the actuator control device having the above-described configuration will be described in more detail with reference to the accompanying drawings.

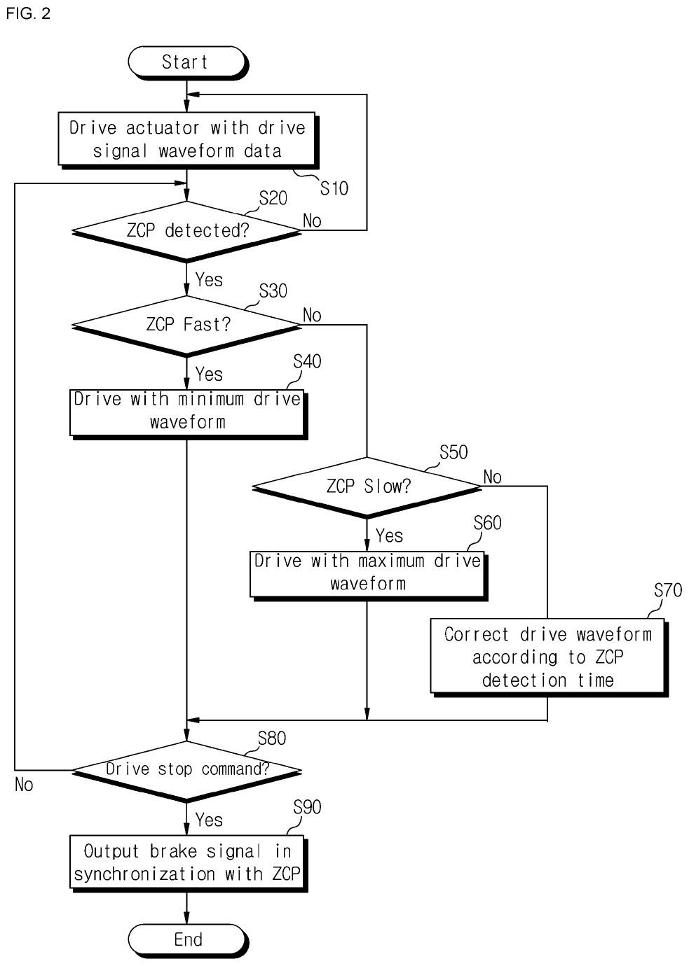

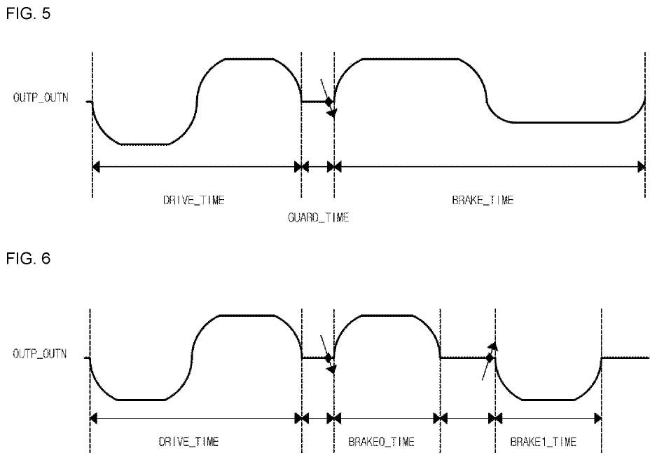

FIG. 2 is a flowchart illustrating a method for controlling an actuator according to an embodiment of the present invention; FIGS. 3 and 4 are exemplary diagrams of drive signal waveforms for explaining an embodiment of the present invention; and FIGS. 5 to 7 respectively exemplify brake signal waveforms for explaining an embodiment of the present invention.

Before describing the embodiments of the present invention, the technical features of the present invention will be summarized.

First, a drive signal for driving the actuator is generated and outputted in accordance with the reference resonance frequency of the actuator. The drive signal waveform data for generating the drive signal waveform is stored in a memory and used for initial driving. After initial driving, driving of the actuator is paused (meaning the guard time interval) and the zero cross point (ZCP) and polarity (direction information) of the BEMF signal are detected to measure the actual resonance period and movement direction of the moving vibrator. When driving the next cycle, it is possible to correct the frequency of the driving waveform constituting the drive signal by calculating the deviation between the expected value and the measured value at the time of zero cross point (ZCP) detection, and by increasing or decreasing the driving waveform of the drive signal stored in the memory.

In this way, if the waveform of the drive signal is matched with the actual resonance frequency and the polarity of the applied voltage is matched to the direction of motion of the vibrator and driven, the maximum vibration force can be obtained with optimal power efficiency.

The actuator control method embodying the above-described technical features is illustrated in FIG. 2.

Referring to FIG. 2, when the resonance frequency correction unit 100 receives an actuator driving command, the actuator is driven with the drive signal waveform data stored in advance in the memory 110 (step S10). In general, the direction of motion of the vibrator is determined in this actuator driving step. The drive signal waveform data contains information on the magnitude of the output signal and determines the duty of the PWM pulse outputted to the actuator drive unit 300.

For reference, the drive signal is composed of a driving time (DRIVE_TIME) interval for applying a voltage to the actuator and a guard time (GUARD_TIME) interval for detecting a BEMF signal, as illustrated in FIG. 3.

The driving time (DRIVE_TIME) interval comprises a minimum driving time (MIN DRIVETIME: stored in the form of drive signal waveform data) previously stored in the memory 110 and a correction time (COMP_TIME) interval in which the driving time changes according to the correction result

The initial value of the correction time (COMP_TIME) interval, COMP_TIME(0), is set as a reference zero cross point (ZCP) detection time (ZXD_TIME) and stored in the memory 110.

The guard time (GUARD_TIME) interval is again composed of GND_TIME, NULL_TIME, and ZXD_REAL. The GND_TIME is necessary to remove the residual energy remaining in the actuator, and NULL_TIME is the time wherein the output of the actuator is turned into a Hi-Z state, and the sensing amplifier and ZCP detection unit 200 are in a standby state to detect the BEMF signal. ZXD_REAL represents the time when the BEMF signal actually reaches the zero cross point.

If the waveform of the drive signal for driving the actuator has a time interval configured as illustrated in FIG. 3,

the first driving time (DRIVE_TIME), DRIVE_TIME(0), is the time excluding the initial guard time (GUARDTIME) from the half cycle of the actuator resonance frequency. In other words,

DRIVE_TIME(0)=(1/f₀)/2−(GND_TIME+NULL_TIME+ZXD_TIME), and

a minimum and maximum DRIVE_TIME can be defined as follows.

MAX_DRIVE_TIME=DRIVE_TIME(0)+COMP_TIME(0)

MIN_DRIVE_TIME=DRIVE_TIME(0)−COMP_TIME(0)

COMP_TIME(0)=ZXD_TIME

After the first drive signal is outputted, DRIVE_TIME(1) of the drive signal of the next cycle is determined by compensating the difference between the reference ZXD_TIME and the actual measured ZXDREAL at DRIVE_TIME(0).

DRIVE_TIME(1) =DRIVE_TIME(0) +[ZXD_REAL(0)-ZXD_TIME] If the above explanation is defined as a general equation, it is as follows.

DRIVE_TIME(n+1)=DRIVE_TIME(n)+[ZXD_REAL(n)−ZXD_TIME]

When referring to the contents described above, the actuator can be driven at a resonance frequency if the length of the driving time (DRIVE_TIME(n)) interval (that is, the frequency of the driving waveform) is corrected by detecting the detection time of the zero cross point of the BEMF signal due to the driving of the actuator and using this as a reference value to be compared with the preset zero cross point detection time.

Accordingly, the data correction unit 120 constituting the resonance frequency correction unit 100 generates the drive signal waveform data stored in the memory 110 and outputs it to a PWM generation unit 140, and checks whether a signal indicating detection of the zero cross point is inputted from the ZCP detection unit 200 (step S20).

When a PWM pulse corresponding to the drive signal waveform data stored in the memory 110 is applied to the actuator drive unit 300, the vibrator, which is an actuator, vibrates, and a BEMF signal by the actuator vibration is inputted to the BEMF amplification unit 400 and amplified.

By setting the noise band at the front end of the ZCP detection unit 200, a BEMF signal of a certain size or less is ignored, and a BEMF signal of a certain size or more is inputted to the ZCP detection unit 200, and thereby, the data correction unit 120 may check whether a signal indicating the detection of a zero cross point (ZCP) is inputted in a guard time interval in which actuator driving is temporarily stopped.

If the zero cross point (ZCP) is detected in step S20, the data correction unit 120 checks whether the zero cross point (ZCP) is Fast (step S30). ‘Zero cross point Fast’ is defined as a case where the zero cross point (ZCP) occurs before the zero cross point detection time (ZXDTIME) preset as a reference value.

According to this definition, ‘ZXD_REAL=0’ and ‘COMP_TIME=−ZXD_TIME’ at the zero cross point (ZCP) Fast, and the driving time interval of the drive signal is reduced to MIN_DRIVE_TIME and it is driven at the maximum resonance frequency (resonance frequency). That is, if the zero cross point (ZCP) is Fast, the data correction unit 120 corrects the length of the driving time interval, and the number of data of the drive signal waveform stored in the memory 110 is adjusted so that the length of the driving time becomes MIN_DRIVE_TIME (this can be defined as a minimum driving waveform) (step S40).

If the zero cross point (ZCP) is Slow (step S50), the data correction unit 120 corrects the length of the driving time interval in a way that the number of data of the drive signal waveform stored in the memory 110 is adjusted so that the length of the driving time becomes MAX_DRIVE_TIME (this can be defined as the maximum driving waveform) (step S60).

For reference, in the present invention, a case in which the zero cross point (ZCP) does not occur until twice the ZXD_TIME is defined as ‘zero cross point (ZCP) Slow’. That is, ZXD_REAL=2*ZXD_TIME, and the driving time interval is increased to MAX_DRIVE_TIME, and is driven at the minimum resonance frequency. Accordingly, the data correction unit 120 adjusts the number of data of the drive signal waveform so that the length of the driving time becomes MAX_DRIVE_TIME as described above.

Meanwhile, if the zero cross point (ZCP) is neither Fast nor Slow, the data correction unit 120 adjust the number of data of the stored drive signal waveform according to the zero cross point (ZCP) detection time (ZXD_REAL-ZXD_TIME is calculated)(step S70).

If the actuator momentarily operates out of the resonance frequency range under abnormal conditions, or if an abnormality occurs in the BEMF signal, it is desirable to control in a way that it is vibrated in a range between the set minimum resonance frequency and maximum resonance frequency.

In summary, the data correction unit 120 outputs a drive signal waveform stored in the memory 110 in response to an actuator driving command and sets an output direction. When an actuator drive end command is received, it is terminated, and if not, the zero cross point (ZCP) of the BEMF signal is detected. When the zero cross point (ZCP) is smaller than the set noise band, the same drive signal waveform is repeatedly outputted to drive the actuator or terminate it as it is. If the zero cross point (ZCP) is Fast when the zero cross point (ZCP) is detected, the number of data of the drive signal waveform stored in the memory 110 is adjusted to become MIN_DRIVE_TIME in the opposite direction, and if the zero cross point (ZCP) is Slow, the number of data of the drive signal waveform is adjusted to become MAX_DRIVE_TIME in the opposite direction. If ZCP is detected within the ZXD_TIME interval, the difference between ZXD_REAL and ZXD_TIME is calculated, and the number of data in the drive signal waveform is adjusted accordingly.

According to the above embodiment, the actuator control device and control method of the present invention initially drives the actuator with a stored drive signal waveform, but because it tracks the resonance frequency of the actuator in a way that the length of the driving time interval of the next cycle is corrected according to the detection time of the zero cross point of the BEMF signal in the guard time interval constituting the drive signal, there is an advantage in that the maximum vibration can be obtained with optimum power efficiency by correcting the resonance frequency of the actuator in real time, which changes according to manufacturing tolerances, mounting conditions, temperature, and aging.

Meanwhile, in the above-described embodiment, a method of correcting the waveform of the drive signal, that is, the length of the driving time interval for tracking the resonance frequency of the actuator has been described, but, as illustrated in FIG. 4, the resonance frequency may also be tracked by fixing a driving time interval and synchronizing to a zero cross point (ZCP).

At this time, the data (DRIVE_TIME) of the drive signal waveform stored in the memory 110 may be determined by the following equation.

DRIVE_TIME<(1/f₀)/2−(GND_TIME+NULL_TIME+2*ZXD_TIME)

Meanwhile, in the case of tracking the resonance frequency of the actuator by fixing the length of the driving time interval and synchronizing to the zero cross point (ZCP), it has the advantage of being able to track not only a half-period square waveform, but also waveforms having various shapes and sizes according to the resonance frequency. In this case, vibrations of various feelings can be made with the resonance frequency.

A further description will be made of an actuator braking step for quickly removing residual vibration of an actuator after the above-described actuator resonance frequency correction driving step.

First, when the data correction unit 120 receives an actuator drive stop command (step S80), as illustrated in FIG. 5 (example of integrated braking waveform), a brake signal waveform (BRAKE_TIME) is outputted (step S90) by synchronizing to the zero cross point (ZCP) of the BEMF signal detected during the guard time (GUARD_TIME) interval in order to remove residual vibration of the actuator after the drive signal waveform (DRIVE_TIME) is terminated. Waveform data of the brake signal can also be stored and used in the memory 110, and as illustrated, the waveform of the brake signal has a waveform in a direction that interferes with the vibration of the actuator.

As mentioned above, by controlling the waveform of the brake signal to be applied to the actuator in synchronization with the zero cross point (ZCP) of the BEMF signal detected during the guard time (GUARD_TIME) interval, the movement of the actuator vibrator can be stopped quickly.

As another implementation method of the above-described actuator braking step, as illustrated in FIG. 6 (example of half-period braking waveform), when the waveform data of the brake signals (BRAKE0_TIME, BRAKE1_TIME, . . . ) having different frequencies and sizes are stored in the memory 110 and synchronized to the zero cross point (ZCP), faster actuator falling time characteristics can be obtained in various ways.

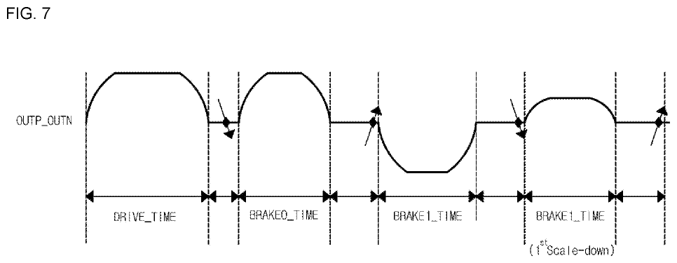

In addition, to prevent the actuator from vibrating again by the brake signal, as illustrated in FIG. 7 (an example of a half-period automatic size adjusting braking waveform), a plurality of brake signals is outputted in a way that the size of one brake signal among the plurality of brake signals may be adjusted according to a scale down ratio to be repeatedly outputted. In FIG. 7, the size of BRAKE1_TIME is scaled down, and the scale down ratio can be selected (for example, 1.0, 0.75, 0.5, 0.25, and the like) according to the falling time characteristic of the actuator.

According to the embodiment of the present invention as described above, the actuator control device and method according to the embodiment of the present invention, since frequencies are adjusted and used after storing waveform data of a drive signal in the memory 110 various waveforms can be driven at a resonance frequency to realize various feelings of vibration, and the effect of adjusting the maximum acceleration and minimizing the dispersion of the actuator acceleration can also be obtained by optimizing the waveform data of the drive signal stored in the memory 110.

In addition, after finding the waveform of the brake signal optimized for the actuator by an experimental method and storing it in the memory 110, and then by applying a brake signal in a direction that interferes with residual vibration according to the zero cross point detected in the section after the actuator is driven, there is an advantage that residual vibration can be stably removed even for a waveform with a short driving time or a small size of a BEMF signal such as a home button.

The above has been described with reference to the embodiments illustrated in the drawings, but these are merely exemplary, and a person of ordinary skill in the art will understand that various modifications and other equivalent embodiments are possible therefrom.

1. An actuator control method having a resonant frequency comprising:
an actuator resonance frequency correction driving step repeatedly generating and outputting a drive signal including a driving time interval for applying a driving voltage to the actuator and a guard time interval for detecting a Back Electro Motive Force (BEMF) signal of the actuator while driving the actuator by correcting the length of the driving time interval according to the detection time of the zero cross point of the BEMF signal detected within the guard time interval; and
an actuator braking step of outputting one or more of brake signals in synchronization with a zero cross point of the BEMF signal detected within the guard time interval in order to remove residual vibration of the actuator.

2. The actuator control method according to claim 1,
wherein in the actuator resonance frequency correction driving step, the driving time interval is shortened when the zero cross point detection time of the BEMF signal is ahead of the pre-stored reference zero cross point detection time, and the driving time interval is extended when it is behind the reference zero cross point detection time.

3. The actuator control method according to claim 1,
wherein in the actuator braking step, brake signals having different frequencies and sizes are continuously outputted.

4. The actuator control method according to claim 1,
wherein a plurality of brake signals is outputted in the actuator braking step, and the size of one brake signal among the plurality of brake signals is repeatedly outputted after adjusting the size according to a scale down ratio.

5. The actuator control method according to claim 1, wherein the break signal waveform and an initial drive signal waveform data, and a reference zero cross point detection time are stored in a memory.

6. An actuator control method having a resonant frequency comprising:
an actuator resonance frequency correction driving step repeatedly generating and outputting a drive signal including a driving time interval for applying a driving voltage to the actuator and a guard time interval for detecting a BEMF signal of the actuator while driving the actuator during a subsequent driving time interval in synchronization with the zero cross point of the BEMF signal detected within the guard time interval; and
an actuator braking step of outputting one or more of brake signals in synchronization with a zero cross point of the BEMF signal detected within the guard time interval in order to remove residual vibration of the actuator.

7. The actuator control method according to claim 6,
wherein in the actuator braking step, brake signals having different frequencies and sizes are continuously outputted.

8. An actuator control device having a resonant frequency comprising:
a zero cross point detection unit for detecting a zero cross point of the BEMF signal according to the actuator driving; and
a resonance frequency correction unit generating and outputting a drive signal for driving the actuator at a resonance frequency,
wherein the resonance frequency correction unit repeatedly generates and outputs a drive signal including a driving time interval for driving the actuator and a guard time interval for detecting the BEMF signal of the actuator, and generates and outputs a drive signal whose length of the driving time interval is corrected according to the detection time of the zero cross point of the BEMF signal detected within the guard time interval.

9. The actuator control device according to claim 8,
wherein the resonance frequency correction unit outputs one or more of brake signals in synchronization with a zero cross point of the BEMF signal detected within the guard time interval in order to remove residual vibration of the actuator.

10. The actuator control device according to claim 9,
wherein the resonance frequency correction unit continuously outputs brake signals having different frequencies and sizes.

11. The actuator control device according to claim 9,
wherein the resonance frequency correction unit outputs a plurality of brake signals, and the size of one of the plurality of brake signals is adjusted according to a scale-down ratio and then repeatedly outputted.

12. The actuator control device according to claim 8,
wherein the resonance frequency correction unit generates and outputs a drive signal wherein the driving time interval is shortened when the zero cross point detection time of the BEMF signal is ahead of the pre-stored reference zero cross point detection time, and the driving time interval is extended when it is behind the reference zero cross point detection time.

13. The actuator control device according to claim 8,
wherein the resonance frequency correction unit comprises:
a memory for storing drive signal waveform data and brake signal waveform data for driving the actuator;
a data correction unit for adjusting the number of data of the drive signal waveform according to the detection time of the zero cross point of the BEMF signal; and
a PWM generation unit for generating a PWM pulse corresponding to the input internal clock and the data number-adjusted drive signal waveform data to output to an actuator drive unit.

14. The actuator control device according to claim 8, further comprising:
a BEMF amplification unit located at the front end of the zero cross point detection unit to amplify the fine-sized BEMF signal.

15. The actuator control method according to claim 2, wherein the break signal waveform and an initial drive signal waveform data, and a reference zero cross point detection time are stored in a memory.

16. The actuator control method according to claim 3, wherein the break signal waveform and an initial drive signal waveform data, and a reference zero cross point detection time are stored in a memory.

17. The actuator control device according to claim 9,
wherein the resonance frequency correction unit generates and outputs a drive signal wherein the driving time interval is shortened when the zero cross point detection time of the BEMF signal is ahead of the pre-stored reference zero cross point detection time, and the driving time interval is extended when it is behind the reference zero cross point detection time.

18. The actuator control device according to claim 10,
wherein the resonance frequency correction unit generates and outputs a drive signal wherein the driving time interval is shortened when the zero cross point detection time of the BEMF signal is ahead of the pre-stored reference zero cross point detection time, and the driving time interval is extended when it is behind the reference zero cross point detection time.

19. The actuator control device according to claim 11,
wherein the resonance frequency correction unit generates and outputs a drive signal wherein the driving time interval is shortened when the zero cross point detection time of the BEMF signal is ahead of the pre-stored reference zero cross point detection time, and the driving time interval is extended when it is behind the reference zero cross point detection time.
